(19) United States
(12) Patent Application Publication
(10) Pub. No.: US 2024/0403673 A1
(43) Pub. Date: Dec. 5, 2024

(54) TRANSFORMER-BASED AUTOMATIC LABELER FOR MISALIGNED ANOMALOUS EVENT WITH TIME SERIES DATA

(71) Applicant: Dell Products L.P., Round Rock, TX (US)

(72) Inventors: Sumanta Kashyapi, Worcester, MA (US); Michael Barnes, Doylestown, PA (US); Niharika Karia, Tewksbury, MA (US); Zachary W. Arnold, Royal Oak, MI (US)

(21) Appl. No.: 18/329,102

(22) Filed: Jun. 5, 2023

(51) Int. Cl. G06N 7/01; G06N 20/00

(52) U.S. Cl. CPC G06N 7/01; G06N 20/00

(57) ABSTRACT

The technology described herein describes training an automatic semi-supervised labeler model, such as including a time series transformer with self-attention encoder, in conjunction with classifier training to produce more precise labels describing when anomalous, rare events occurred. The automatic labeler assigns a probability distribution parameterized by distribution parameters over a sample window. A classifier outputs an approximation of distribution parameters for an imprecise label (secondary event) correlated with the anomalous event. The approximation distribution along with the secondary event distribution are input into a loss function, which couples the automatic labeler to the classifier in a feedback loop. The loss function is optimized over iterations of the loop, with the loss minimized when the automatic labeler outputs the correct label. Once trained, additional labels can be automatically generated for further training. A model trained with more precisely labeled events can then predict an anomalous event given previously unseen data.

### BACKGROUND

In artificial intelligence/machine learning, the better the training data, the better that robust models, such as classifiers or regressors, can be trained, generally with less overfitting. In various scenarios, there are only imprecise labels available for training. For example, consider anomalous (rare) events that occur in time series data, such as hardware failures, data unavailable events, data loss events and the like, in which telemetry data is available but there is no precise time of detection of such an event. There is often a service request or the like (e.g., incident or complaint) reported after an anomalous event, but the reporting time is imprecise and misaligned; as one time such an event may be reported after several hours, which another time such an event may be reported some days later, and so on.

To train accurate models with imprecise labels, most recent approaches revolve around using fewer labels generated by subject matter experts, modeling the label generation as a stochastic process, and hand-crafting heuristics/rules to generate labels. None of these are efficient approaches, some tend to provide only a relatively small amount of training data, and often the labels are of low quality.

One straightforward approach for handling imprecise labels in a supervised learning setting is to identify certain aspects of the labels as hyperparameters. These hyperparameters are tuned based on empirical results. For example, with a data unavailable/data loss prediction problem, to train a data unavailable/data loss classifier using the telemetry signals as input to determine a future data unavailable/data loss event, a system has to provide the telemetry data before the event as positive samples. As there is no way to know when the system started to show symptoms, the length of the sampling window is a hyperparameter that can be tuned through empirical study. This is a computationally expensive and inefficient process as the same experiments are repeated with certain choices of hyperparameters.

### BRIEF DESCRIPTION OF THE DRAWINGS

The technology described herein is illustrated by way of example and not limited in the accompanying figures in which like reference numerals indicate similar elements and in which:

FIG. 1 is a block diagram of an example system/architecture for automatically generating training labels from time series data when an anomalous event occurred during the timeframe of the time series data and there is only a secondary, misaligned label as to the time of occurrence, in accordance with various aspects and implementations of the subject disclosure.

FIG. 2 is a block diagram representing an example approach to training a classifier once an automatic labeler has been trained (as in FIG. 1), in accordance with various aspects and implementations of the subject disclosure.

FIG. 3 depicts an example representation of training an automatic labeler and a classifier/regressor model in a feedback loop, in accordance with various aspects and implementations of the subject disclosure.

FIG. 4 is a flow diagram showing example operations related to determining a more precise label as to an actual time at which an anomalous event occurred, by coupling an automatic semi-supervised labeler model to a machine learning model via a feedback loop corresponding to a loss function, in accordance with various aspects and implementations of the subject disclosure.

FIG. 5 is a flow diagram showing example operations related to training a machine learning model and a time series transformer with self-attention to obtain training data for training a prediction model to predict a future anomalous event, in accordance with various aspects and implementations of the subject disclosure.

FIG. 6 is a flow diagram showing example operations related to adjusting distribution parameters in a feedback loop to reduce a loss value that represents a difference between two other distributions, in accordance with various aspects and implementations of the subject disclosure.

FIG. 7 is a block diagram representing an example computing environment into which aspects of the subject matter described herein may be incorporated.

FIG. 8 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards producing high-quality training data at scale that provides a more accurate representation of the actual temporal occurrence of a misaligned rare event, referred to herein as an “anomalous” event. In general, the technology described herein models training as a learning problem by parameterizing the uncertainty in the labels. For example, with an anomalous event such as a data loss/data unavailable event that occurred sometime within a set of telemetry data, a probability distribution over time with learnable parameters identifies the likelihood (to a high probability) of a telemetry data point to be treated as part of a positive sample. Along with alleviating the need to conduct a hyperparameter search, the trained model can be used to label unseen data to produce additional training data.

By way of example, consider a rare event to be predicted. Given enough data samples with corresponding labels, supervised artificial intelligence/machine learning models can be trained to predict such events. However, the quality of existing labels is not always adequate, e.g., in a scenario directed to predicting data unavailable/data loss events from telemetry data received from customer. Without a quality, relatively precisely labeled dataset, supervised artificial intelligence/machine learning models are almost certain to fail. As will be understood, the technology described herein can produce the needed high-quality training dataset at scale.

It should be understood that any of the examples herein are non-limiting. Thus, any of the embodiments, aspects, concepts, structures, functionalities or examples described herein are non-limiting, and the technology may be used in various ways that provide benefits and advantages in artificial intelligence/machine learning/model training in general. It also should be noted that terms used herein, such as “optimize” or “optimal” and the like (e.g., “maximize,” “minimize” and so on) only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

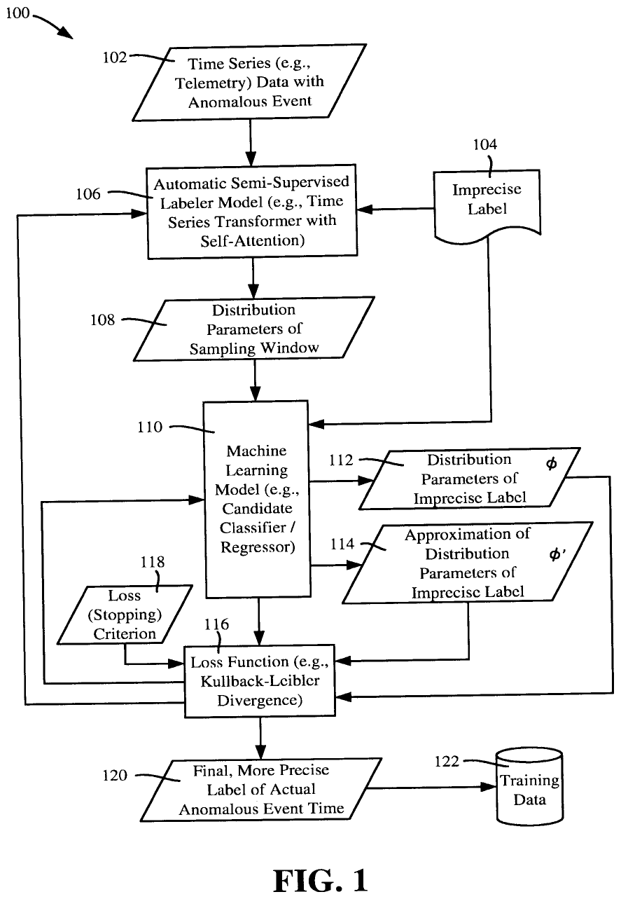

FIG. 1 is an example representation of a system/architecture 100 which, in general and as described herein generates more precise training labels for anomalous events. The anomalous events are present in one or more sets of time series data 102, such as telemetry data obtained (e.g., captured and received) by the system 100, e.g., sent by customers. In this example, the telemetry data includes information related to an anomalous (rare) event such as a data loss event.

Any type of time series data that can include a rare event may be processed as described herein. Examples of time series/telemetry data can include, but are not limited to, processor accelerator inventory and monitoring data, CPU/GPU metrics, storage drive monitoring data, memory monitoring data, serial data log messages, transceiver inventory monitoring data, device configuration/settings data, device hardware and firmware reporting, hardware performance data, memory bandwidth and I/O usage data, performance data and diagnostic statistic data, sensor-related data (e.g., voltage, temperature, power, connectivity status, intrusion detection), diagnostic data, controller log data, and so on.

Currently the best data source that can be used to determine the actual time of occurrence for an improperly aligned rare event is the time that anomalous event was reported or recorded, shown in FIG. 1 as an imprecise label 104. Although imprecise in that the reporting time is unpredictable/variably inconsistent with the actual event time, the time of the imprecise label is indeed correlated with the anomalous event. After preliminary data cleaning, such as filtering out reports related to other events, the system 100 can identify the timestamp for when the anomalous event was reported or recorded.

As described herein and in general, the time series data 102 and the imprecise label 104 are input into an automatic semi-supervised labeler model 106. In one implementation, this is a time series transformer with self-attention, in which in general, a time series transformer is a deep learning model based on a self-attention mechanism for modeling; such a transformer processes the time series data to learn dependencies within a sampling of time series data using self-attention techniques, rather than using recurrence and convolutions. For example, when used with the technology described herein, the TimeSeriesTransformer implemented as part of the Hugging Face® library has proved superior in labeling when compared to bidirectional long short-term memory—conditional random field models for sequence tagging (BILSTM) with multihead attention.

As described herein, the automatic semi-supervised labeler model 106 (e.g., time series transformer with self-attention) outputs distribution parameters of the sampling window, that is, a parametric candidate distribution suitable for the type of data, which is used as the output from the automatic labeler (model) 106. The parametric candidate distribution is denoted herein as θ, initialized with θ*. Note that θ* can be a uniform (e.g., Gaussian) distribution known to have occurred at least before the timestamp of the imprecise label, and thus with an ending point at that timestamp, with a starting point of the distribution being chosen as some reasonable time prior to the reporting, based on some general knowledge of the data and/or the source of the report.

The system 100 includes a machine learning model 110, e.g., an efficient, differentiable and lightweight classifier/regressor model that has been identified as performing well in rare event detection in time-series data (e.g., anomaly detection). Linear/logistic regression models, fully-connected neural networks, recurrent neural networks (RNNs) can be considered as suitable models, which can be dependent on the type of data and the type of anomalous event to be determined. The model 110 can alternatively be referred to herein in the examples as a candidate classifier/regressor.

Thus, as will be understood, given the candidate classifier/regressor 110, the candidate parametric distribution 108, the telemetry data 102 and the imprecise, misaligned rare event labels 104, the technology described herein operates to train the automatic labeler model 106 to maximize the accuracy of the classifier/regressor model 110. Note that unlike adversarial learning, in one implementation of the system 100, both models (the automatic labeler model 106 and the candidate model 110) train in unison to optimize a common goal, rather than deceiving a discriminative model (e.g., generative adversarial network, or GAN models).

In general, the training of the models is performed by obtaining the actual distribution parameters, φ of the imprecise label, (data block 112), and an approximation of the distribution parameters φ′ of the imprecise label (data block 114). A loss function 116 (e.g., the Kullback-Leibler divergence loss function) couples the automatic labeler model 106 to the classifier/regressor model 110 as described herein, e.g., by optimizing/minimizing the loss between the actual distribution parameters and approximation of the distribution parameters (Optimize Loss [symbol] (φ, φ′)) in a feedback loop until some defined stopping criterion 118 (sufficiently low loss) is satisfied.

The result is a final, more precise label 120 that includes a more precise estimate of the time of the anomalous event. The choice of the loss function [symbol] is significant, because the loss function operating on the difference between the distributions ensures that the candidate classifier 110 optimizes the loss value only when the automatic labeler 106 provides the correct label(s). The more precise label 120 is maintained as part of the training data 122 that is used to train any classifier (or regressor, as appropriate) suitable for detection of anomalous events of this type, possibly a more sophisticated classifier than that used in the training of the automatic labeler and the determination of the label as in FIG. 1.

After the automatic labeler 106 is trained, it can be used to predict future rare events. For example, once trained, the automatic labeler 106 is used to generate additional, large scale training data that can be used to train the rare event predictor models using the same candidate classifier/regressor as in FIG. 1, or even more sophisticated models. A time-series forecast model, including models already in existence (e.g., Facebook® Prophet), can be used to generate future time-series given a set of current telemetry data. This generated future time-series can be labeled by the automatic labeler 106 denoting the possibility of any rare event in the future.

More particularly, consider a rare event to be predicted, denoted as E, along with a set of auxiliary events J with timestamps that are correlated with E, e.g., the registering of a service request (SR) or the like as one of the auxiliary events related to a particular data unavailable/data loss event. The timestamps recorded as part of these events in J can be used as a weak label for the event of interest E. The technology described herein can deduce quality training samples suitable for predicting the rare event E from the labels of auxiliary events J.

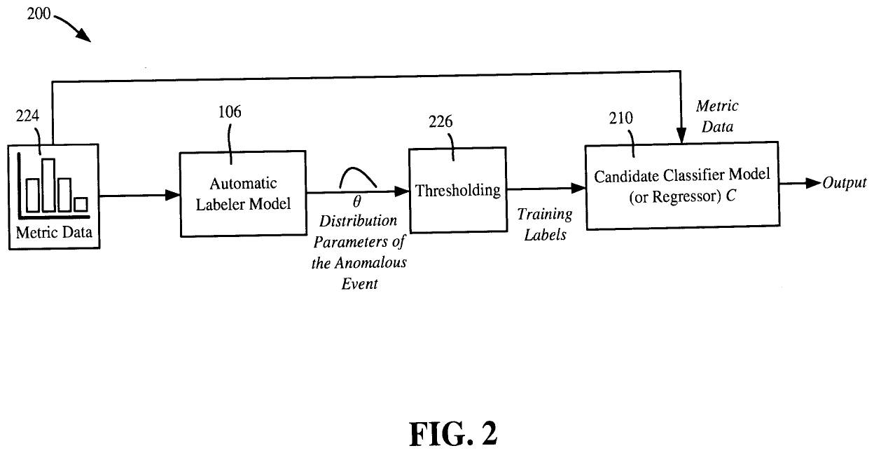

An overarching approach as described herein is depicted in FIG. 2, showing a more a formal description of a proposed model that generates these training samples from metric data 224. A candidate classifier (or regressor depending on the specific use case) model 210 is denoted as C that can classify telemetry samples into normal events or events related to the rare event E. It is known that the model C 210 can achieve sufficient accuracy when trained with accurate examples of instances of anomalous events such as E. Instead of sampling streams of telemetry signals and assigning them binary labels, the automatic labeler model 106 assigns a probability distribution parameterized by θ_{E} over a sample window pertaining to the event E. The automatic labeler model 106 itself is a semi-supervised model that takes information about the set of auxiliary events J as input. To train the model C 210, however, predetermined thresholds T_{E} (block 224) can be applied to convert the probability distribution of a sample into a binary label.

The overall approach described with reference to FIG. 2 illustrates how the automatic labeler model 106 is meant to be used to train any suitable candidate classifier model 210. However, being a semi-supervised model itself, the automatic labeler model 106 is trained, e.g., as generally described with reference to FIG. 1.

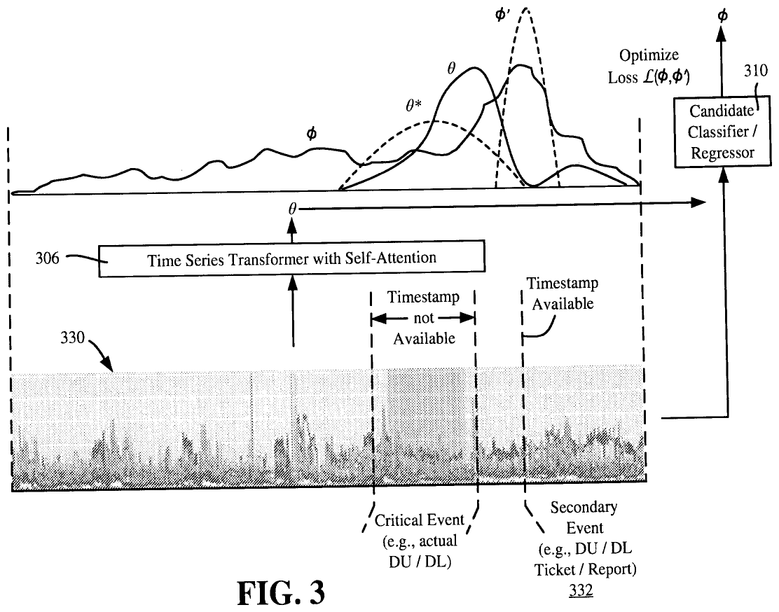

FIG. 3 depicts additional details of the training loop, given a set of telemetry data 330 that contains information related to the anomalous event and a secondary event 332 correlated to the anomalous event. The automatic labeler model 106, which in the example of FIG. 3 is a time series transformer with self-attention 306, is initialized with an output distribution parameter denoted θ* based on the secondary label 332. The set of one or more weak event labels are approximated by another distribution, denoted ϕ′. The candidate classifier 310, which is used to predict the event, provides a probability distribution of its output denoted as ϕ. The optimization criterion for the training loop is the loss value computed using ϕ and ϕ′, e.g., Kullback-Leibler divergence loss.

With information corresponding to the loss function result fed back, the time series transformer with self-attention 306 adjusts the distribution parameters θ over iterations of the feedback loop. As set forth herein, the loss function [symbol] that determines the difference between actual and approximated distributions ϕ and ϕ′, respectively, is significant in that the candidate classifier or regressor model 310 optimizes the loss value (satisfies the loss stopping criterion) only when the time series transformer with self-attention 306 provides more precise, sufficiently correct label(s).

Thus, the technology described herein directly models the uncertainty contained in the imprecise labels by a parameterized distribution, which is optimized during the training, by coupling the automatic labeler with a candidate classifier/regressor via an optimization loop, such that the final loss and thus the actual time of the event is predicted to a significantly higher likelihood (relative to when time series transformer first emits the distribution). The result is high-quality training data at scale that provides a more accurate representation of the actual temporal occurrence of misaligned rare events, which are common in numerous telemetry data scenarios. Note that with the better training data generated by the automatic labeler as described herein, training of robust models with less overfitting is achieved, which results in improving the accuracy of the classifier/regressor model.

Thus, provided there is correlation between a rare event and when the rare event is reported/recorded, that is, there is some reasonable proximity between the occurrence of the event and its reporting after the anomalous event happened, the necessary information related to the actual temporal occurrence of rare events can be inferred from the telemetry data, and indeed, only from the telemetry data. Thus, by having the labeler emit a distribution that links time series data to labels as part of training, which determines the label to the point where really occurred, the weights and biases are set up in the model to do accurate predictions on new data, even though initially neither the length of the anomalous event nor the gap between the anomalous event and the secondary event when reported are only correlated in that the anomalous event is known to have occurred prior to the time of the secondary event. More labels can be similarly generated, that is, using the trained transformer to label more training data eliminates the scarcity of training data while modeling the uncertainty of timestamps of anomalous (e.g., critical) events. As a result, a candidate classifier/regressor model achieves a higher accuracy and lower overfitting because the training data is labeled with more precise timestamps as of the actual temporal occurrences of such rare events, even though the labeler initially has only labels with inexact timestamps/uncertainty in training data, and few, if any, good quality training labels to start with.

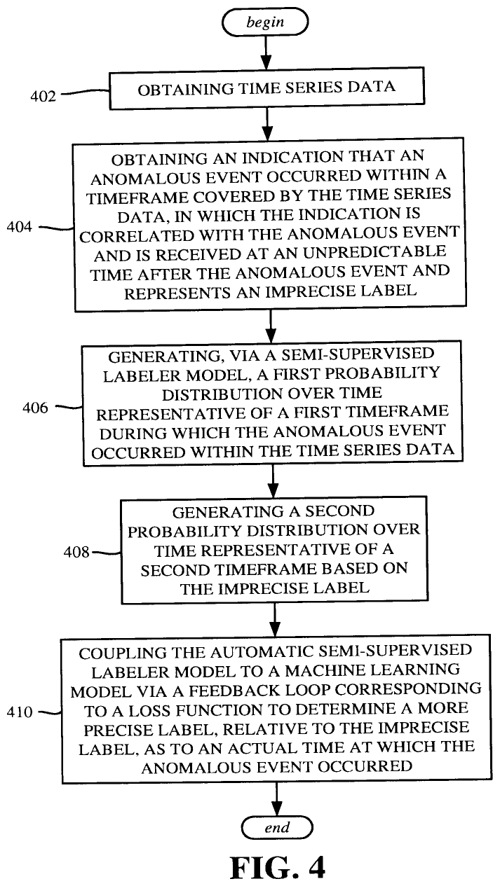

One or more aspects can be embodied in a system, such as represented in the example operations of FIG. 4, and for example can include a memory that stores computer executable components and/or operations, and a processor that executes computer executable components and/or operations stored in the memory. Example operations can include operation 402, which represents obtaining time series data. Example operation 404 represents obtaining an indication that an anomalous event occurred within a timeframe covered by the time series data, in which the indication is correlated with the anomalous event and is received at an unpredictable time after the anomalous event and represents an imprecise label. Example operation 406 represents generating, via a semi-supervised labeler model, a first probability distribution over time representative of a first timeframe during which the anomalous event occurred within the time series data. Example operation 408 represents generating a second probability distribution over time representative of a second timeframe based on the imprecise label. Example operation 410 represents coupling the automatic semi-supervised labeler model to a machine learning model via a feedback loop corresponding to a loss function to determine a more precise label, relative to the imprecise label, as to an actual time at which the anomalous event occurred.

Further operations can include inputting the first probability distribution over time and the more precise label as training data to train a classifier to predict future anomalous events.

Further operations can include inputting the first probability distribution over time and the more precise label as training data to train a regressor to predict future anomalous events.

Further operations can include inputting the first probability distribution over time and the more precise label to a time series forecast model to generate future time series data.

The automatic semi-supervised labeler model can include a time series transformer encoder with self-attention, and generating the first probability distribution can include inputting the time series data into the time series transformer encoder with self-attention.

The machine learning model can include a classifier.

The machine learning model can include a regressor.

The loss function can include a Kullback-Leibler divergence loss function.

The time series data can include telemetry data.

The anomalous event can include a data loss event, and the imprecise label can include a report received at a reporting time that is reported at the unpredictable time after the anomalous event occurred.

The anomalous event can include a data unavailable event, and the imprecise label can include a report received at a reporting time that is reported at the unpredictable time after the anomalous event occurred.

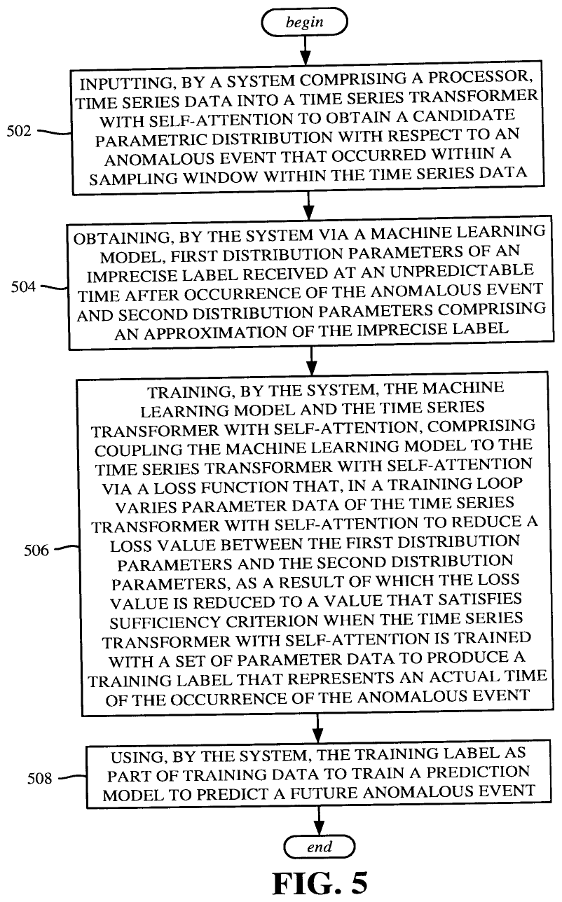

One or more example aspects, such as corresponding to example operations of a method, are represented in FIG. 5. Example operation 502 represents inputting, by a system comprising a processor, time series data into a time series transformer with self-attention to obtain a candidate parametric distribution with respect to an anomalous event that occurred within a sampling window within the time series data. Example operation 504 represents obtaining, by the system via a machine learning model, first distribution parameters of an imprecise label received at an unpredictable time after occurrence of the anomalous event and second distribution parameters comprising an approximation of the imprecise label. Example operation 506 represents training, by the system, the machine learning model and the time series transformer with self-attention, comprising coupling the machine learning model to the time series transformer with self-attention via a loss function that, in a training loop, varies parameter data of the time series transformer with self-attention to reduce a loss value between the first distribution parameters and the second distribution parameters, as a result of which the loss value is reduced to a value that satisfies sufficiency criterion when the time series transformer with self-attention is trained with a set of parameter data to produce a training label that represents an actual time of the occurrence of the anomalous event. Example operation 508 represents using, by the system, the training label as part of training data to train a prediction model to predict a future anomalous event.

Further operations can include, after training, generating, by the system, additional training data, other than the training data, via the time series transformer with self-attention and the machine learning model.

The machine learning model can include a classifier or a regressor.

The machine learning model can include the prediction model.

Inputting the time series data can include inputting telemetry data into the time series transformer with self-attention.

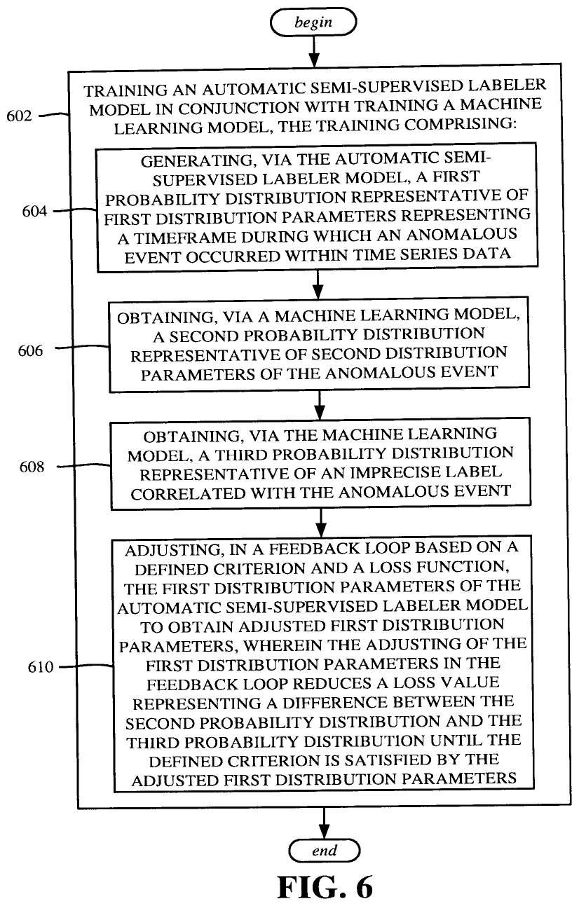

FIG. 6 summarizes various example operations, e.g., corresponding to a machine-readable medium, comprising executable instructions that, when executed by a processor, facilitate performance of operations. Example operation 602 represents training an automatic semi-supervised labeler model in conjunction with training a machine learning model, the training including, for example, operations 604, 606, 608 and 610 of FIG. 6. Example operation 604 represents generating, via the automatic semi-supervised labeler model, a first probability distribution representative of first distribution parameters representing a timeframe during which an anomalous event occurred within time series data. Example operation 606 represents obtaining, via a machine learning model, a second probability distribution representative of second distribution parameters of the anomalous event. Example operation 608 represents obtaining, via the machine learning model, a third probability distribution representative of an imprecise label correlated with the anomalous event. Example operation 610 represents adjusting, in a feedback loop based on a defined criterion and a loss function, the first distribution parameters of the automatic semi-supervised labeler model to obtain adjusted first distribution parameters, wherein the adjusting of the first distribution parameters in the feedback loop reduces a loss value representing a difference between the second probability distribution and the third probability distribution until the defined criterion is satisfied by the adjusted first distribution parameters.

The automatic semi-supervised labeler model can include a time series transformer encoder with self-attention, and further operations can include training a classifier via the time series transformer encoder with self-attention to classify input metric data as being related to the anomalous event or unrelated to the anomalous event. The non-transitory machine-readable medium of claim 17, wherein the automatic semi-supervised labeler model can include a time series transformer encoder with self-attention, and further operations can include training a classifier or regressor via the time series transformer encoder with self-attention to predict a future anomalous event. The automatic semi-supervised labeler model can include a time series transformer encoder with self-attention, and further operations can include generating, with the time series transformer encoder with self-attention, training data usable as input to train a prediction model to predict a future anomalous event.

As can be seen, the technology described herein facilitates generation of more precise labels with minimum human intervention, suitable for training classifier models. The technology described herein directly models the uncertainty contained in the imprecise labels by a parameterized distribution that is optimized during the training, instead of for example, relying on inputs from subject matter experts in obtaining initial supervision. That is, the technology described herein models the determination of accurate labels as a learning problem by parameterizing the uncertainty in the labels. For the same example as above, a probability distribution over time with learnable parameters identifies the likelihood of telemetry data point to be treated as part of a positive sample. This alleviates the need to conduct hyperparameter search, e.g., without tuning the length of a sampling window as a hyperparameter. Moreover, the trained model can be used to label unseen data to produce more training data.

As can be readily appreciated, although examples herein have been directed to certain critical events in telemetry data, the technology described herein is suitable for training and inference on other deep learning models where an auxiliary label is not aligned (e.g., occurs at any random time), to predict when actual event happened with the data so to obtain better data and better prediction.

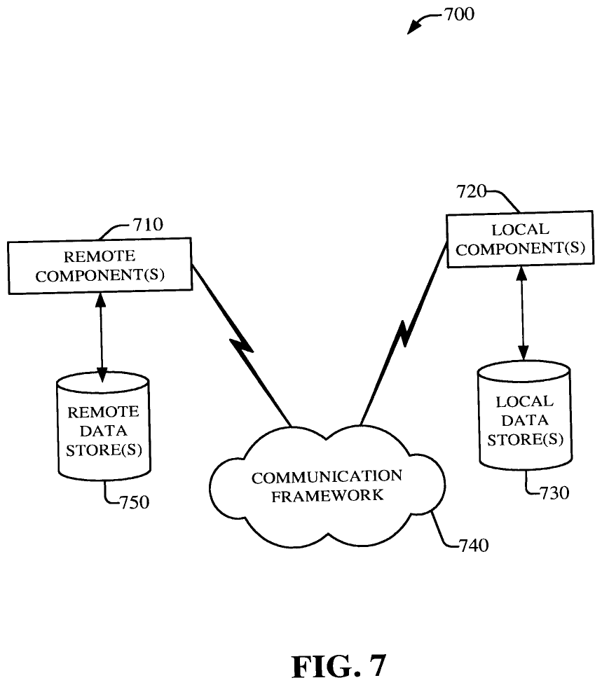

FIG. 7 is a schematic block diagram of a computing environment 700 with which the disclosed subject matter can interact. The system 700 can include one or more remote component(s) 710. The remote component(s) 710 can be hardware and/or software (e.g., threads, processes, computing devices). In some embodiments, remote component(s) 710 can be a distributed computer system, connected to a local automatic scaling component and/or programs that use the resources of a distributed computer system, via communication framework 740. Communication framework 740 can include wired network devices, wireless network devices, mobile devices, wearable devices, radio access network devices, gateway devices, femtocell devices, servers, etc.

The system 700 also can include one or more local component(s) 720. The local component(s) 720 can be hardware and/or software (e.g., threads, processes, computing devices). In some embodiments, local component(s) 720 can include an automatic scaling component and/or programs that communicate/use the remote resources 710, etc., connected to a remotely located distributed computing system via communication framework 740.

One possible communication between a remote component(s) 710 and a local component(s) 720 can be in the form of a data packet adapted to be transmitted between two or more computer processes. Another possible communication between a remote component(s) 710 and a local component(s) 720 can be in the form of circuit-switched data adapted to be transmitted between two or more computer processes in radio time slots. The system 700 comprises a communication framework 740 that can be employed to facilitate communications between the remote component(s) 710 and the local component(s) 720, and can comprise an air interface, e.g., Uu interface of a UMTS network, via a long-term evolution (LTE) network, etc. Remote component(s) 710 can be operably connected to one or more remote data store(s) 750, such as a hard drive, solid state drive, SIM card, device memory, etc., that can be employed to store information on the remote component(s) 710 side of communication framework 740. Similarly, local component(s) 720 can be operably connected to one or more local data store(s) 730, that can be employed to store information on the local component(s) 720 side of communication framework 740.

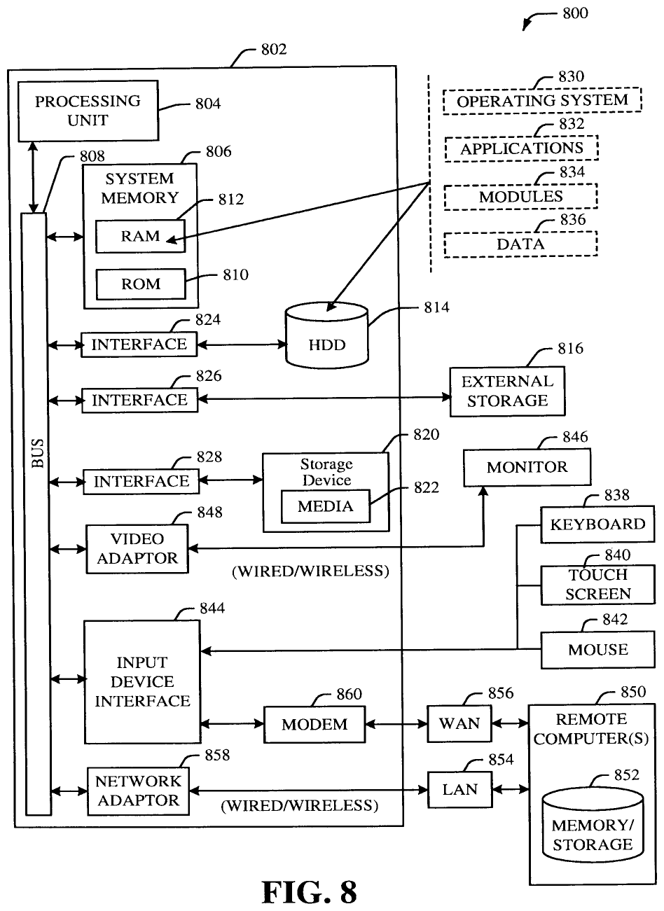

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), and can include one or more external storage devices 816 (e.g., a magnetic floppy disk drive (FDD) 816, a memory stick or flash drive reader, a memory card reader, etc.). While the internal HDD 814 is illustrated as located within the computer 802, the internal HDD 814 can also be configured for external use in a suitable chassis (not shown). Additionally, while not shown in environment 800, a solid state drive (SSD) could be used in addition to, or in place of, an HDD 814.

Other internal or external storage can include at least one other storage device 820 with storage media 822 (e.g., a solid state storage device, a nonvolatile memory device, and/or an optical disk drive that can read or write from removable media such as a CD-ROM disc, a DVD, a BD, etc.). The external storage 816 can be facilitated by a network virtual machine. The HDD 814, external storage device(s) 816 and storage device (e.g., drive) 820 can be connected to the system bus 808 by an HDD interface 824, an external storage interface 826 and a drive interface 828, respectively.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can be enabled with a security module, such as a trusted processing module (TPM). For instance, with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 894 serial port, a game port, a USB port, an IR interface, a BLUETOOTH® interface, etc.

A monitor 846 or other type of display device can be also connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are examples and other means of establishing a communications link between the computers can be used.

When used in either a LAN or WAN networking environment, the computer 802 can access cloud storage systems or other network-based storage systems in addition to, or in place of, external storage devices 816 as described above. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining time series data;
obtaining an indication that an anomalous event occurred within a timeframe covered by the time series data, in which the indication is correlated with the anomalous event and is received at an unpredictable time after the anomalous event and represents an imprecise label;
generating, via a semi-supervised labeler model, a first probability distribution over time representative of a first timeframe during which the anomalous event occurred within the time series data;
generating a second probability distribution over time representative of a second timeframe based on the imprecise label; and
coupling the automatic semi-supervised labeler model to a machine learning model via a feedback loop corresponding to a loss function to determine a more precise label, relative to the imprecise label, as to an actual time at which the anomalous event occurred.

2. The system of claim 1, wherein the operations further comprise inputting the first probability distribution over time and the more precise label as training data to train a classifier to predict future anomalous events.

3. The system of claim 1, wherein the operations further comprise inputting the first probability distribution over time and the more precise label as training data to train a regressor to predict future anomalous events.

4. The system of claim 1, wherein the operations further comprise inputting the first probability distribution over time and the more precise label to a time series forecast model to generate future time series data.

5. The system of claim 1, wherein the automatic semi-supervised labeler model comprises a time series transformer encoder with self-attention, and wherein the generating of the first probability distribution comprises inputting the time series data into the time series transformer encoder with self-attention.

6. The system of claim 1, wherein the machine learning model comprises a classifier.

7. The system of claim 1, wherein the machine learning model comprises a regressor.

8. The system of claim 1, wherein the loss function comprises a Kullback-Leibler divergence loss function.

9. The system of claim 1, wherein the time series data comprises telemetry data.

10. The system of claim 1, wherein the anomalous event comprises a data loss event, and wherein the imprecise label comprises a report received at a reporting time that is reported at the unpredictable time after the anomalous event occurred.

11. The system of claim 1, wherein the anomalous event comprises a data unavailable event, and wherein the imprecise label comprises a report received at a reporting time that is reported at the unpredictable time after the anomalous event occurred.

12. A method, comprising:
inputting, by a system comprising a processor, time series data into a time series transformer with self-attention to obtain a candidate parametric distribution with respect to an anomalous event that occurred within a sampling window within the time series data;
obtaining, by the system via a machine learning model, first distribution parameters of an imprecise label received at an unpredictable time after occurrence of the anomalous event and second distribution parameters comprising an approximation of the imprecise label;
training, by the system, the machine learning model and the time series transformer with self-attention, comprising coupling the machine learning model to the time series transformer with self-attention via a loss function that, in a training loop, varies parameter data of the time series transformer with self-attention to reduce a loss value between the first distribution parameters and the second distribution parameters, as a result of which the loss value is reduced to a value that satisfies sufficiency criterion when the time series transformer with self-attention is trained with a set of parameter data to produce a training label that represents an actual time of the occurrence of the anomalous event; and
using, by the system, the training label as part of training data to train a prediction model to predict a future anomalous event.

13. The method of claim 12, further comprising after training, generating, by the system, additional training data, other than the training data, via the time series transformer with self-attention and the machine learning model.

14. The method of claim 12, wherein the machine learning model comprises a classifier or a regressor.

15. The method of claim 12, wherein the machine learning model comprises the prediction model.

16. The method of claim 12, wherein the inputting of the time series data comprises inputting telemetry data into the time series transformer with self-attention.

17. A non-transitory machine-readable medium, comprising executable instructions that, when executed by a processor, facilitate performance of operations, the operations comprising:
training an automatic semi-supervised labeler model in conjunction with training a machine learning model, the training comprising:
generating, via the automatic semi-supervised labeler model, a first probability distribution representative of first distribution parameters representing a timeframe during which an anomalous event occurred within time series data;
obtaining, via a machine learning model, a second probability distribution representative of second distribution parameters of the anomalous event;
obtaining, via the machine learning model, a third probability distribution representative of an imprecise label correlated with the anomalous event; and
adjusting, in a feedback loop based on a defined criterion and a loss function, the first distribution parameters of the automatic semi-supervised labeler model to obtain adjusted first distribution parameters, wherein the adjusting of the first distribution parameters in the feedback loop reduces a loss value representing a difference between the second probability distribution and the third probability distribution until the defined criterion is satisfied by the adjusted first distribution parameters.

18. The non-transitory machine-readable medium of claim 17, wherein the automatic semi-supervised labeler model comprises a time series transformer encoder with self-attention, and wherein the operations further comprise training a classifier via the time series transformer encoder with self-attention to classify input metric data as being related to the anomalous event or unrelated to the anomalous event.

19. The non-transitory machine-readable medium of claim 17, wherein the automatic semi-supervised labeler model comprises a time series transformer encoder with self-attention, and wherein the operations further comprise training a classifier or regressor via the time series transformer encoder with self-attention to predict a future anomalous event.

20. The non-transitory machine-readable medium of claim 17, wherein the automatic semi-supervised labeler model comprises a time series transformer encoder with self-attention, and wherein the operations further comprise generating, with the time series transformer encoder with self-attention, training data usable as input to train a prediction model to predict a future anomalous event.
